(19) United States
(12) Patent Application Publication
(10) Pub. No.: US 2022/0410391 A1
(43) Pub. Date: Dec. 29, 2022

(54) SENSOR-BASED CONSTRUCTION OF COMPLEX SCENES FOR AUTONOMOUS MACHINES

(71) Applicant: Siemens Aktiengesellschaft, Munich (DE)

(72) Inventors: Juan L. Aparicio Ojea, Moraga, CA (US); Heiko Claussen, Wayland, MA (US); Ines Ugalde Diaz, Redwood City, CA (US); Martin Sehr, Kensington, CA (US); Eugen Solowjow, Berkeley, CA (US); Chengtao Wen, Redwood City, CA (US); Wei Xi Xia, Daly City, CA (US); Xiaowen Yu, Union City, CA (US); Shashank Tamaskar, Mohali (IN)

(21) Appl. No.: 17/778,909

(22) PCT Filed: Nov. 22, 2019
(86) PCT No.: PCT/US2019/062757

§ 371 Date: May 23, 2022

(51) Int. Cl. B25J 9/16

(52) U.S. Cl. CPC B25J 9/1661; B25J 9/161; B25J 9/1697

(57) ABSTRACT

In current applications of autonomous machines in industrial settings, the environment, in particular the devices and systems with which the machine interacts, is known such that the autonomous machine can operate in the particular environment successfully. Thus, current approaches to automating tasks within varying environments, for instance complex environments having uncertainties, lack capabilities and efficiencies. In an example aspect, a method for operating an autonomous machine within a physical environment includes detecting an object within the physical environment. The autonomous machine can determine and perform a principle of operation associated with a detected subcomponent of the object, so as to complete a task that requires that the autonomous machine interacts with the object. In some cases, the autonomous machine has not previously encountered the object.

### TECHNICAL FIELD

This application relates to autonomous machines. The technology described herein is particularly well-suited for, but not limited to, modeling environments for autonomous machines in industrial settings.

### BACKGROUND

A current objective of the fourth industrial revolution is to drive mass customization to the cost of mass production. Autonomous machines can help attain this objective, for example, if the machines can operate without having to be programmed with specific and detailed instructions, for instance instructions for robotic waypoints or manually taught paths. Autonomous machines in industrial settings, however, often need to interact with a large set of highly variant and sometimes complex systems. The systems with which such autonomous machines may need to operate often include devices, which can be referred to as brownfield devices, that are already installed in the field.

By way of example, when trying to automate a baking process in a given environment using an autonomous mobile robot, in some cases, the robot would encounter a large variation of devices and device types. Such devices may have manual control interfaces, manual doors, or varying procedures for setting time and temperatures. Continuing with the baking example, further issues may arise if a human interacts with the environment without knowledge of the autonomous robot. For example, a human may open a door in the environment, remove (or add) products from the environment, change settings of devices within the environment, or the like.

It is recognized herein that building a model that captures the variability of a given environment and of devices within the environment can be complex, if not impossible, given the uncertainty of humans or other objects that also interact within the environment. In current applications of autonomous machines in industrial settings, the environment, in particular the devices and systems with which the machine interacts, is known such that the autonomous machine can operate in the particular environment successfully. Thus, current approaches to automating tasks within varying environments, for instance complex environments having uncertainties, lack capabilities and efficiencies.

### SUMMARY

Embodiments of the invention address and overcome one or more of the described-herein shortcomings by providing methods, systems, and apparatuses that automatically generate complex environmental models, so as to operate autonomous machines in various environments

In an example aspect, a method for operating an autonomous machine within a physical environment includes detecting an object within the physical environment. The object can define a plurality of subcomponents. The method can further include receiving a task that requires that the autonomous machine interacts with the object. A subcomponent of the plurality of subcomponents can be detected so as to define a detected subcomponent. Further, a classification of the detected subcomponent can be determined. Based on the classification of the detected subcomponent, a principle of operation associated with the detected subcomponent can be determined. Then the autonomous machine can perform the principle of operation associated with detected subcomponent, so as to complete the task that requires that the autonomous machine interacts with the object. In some cases, the autonomous machine has not previously encountered the object.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows an example system in an example physical environment that includes an autonomous machine that interacts with an object, in accordance with an example embodiment.

FIG. 2 shows the autonomous machine in another example physical environment interacting with another object that defines various subcomponents, in accordance with another example embodiment.

FIG. 3 is a block diagram of an example neural network (CNN) model or system in accordance with various example embodiments.

FIG. 4 is a flow diagram for operating an autonomous machine, in accordance with an example embodiment.

FIG. 5 shows an example of a computing environment within which embodiments of the disclosure may be implemented.

### DETAILED DESCRIPTION

Embodiments of the invention address and overcome one or more of the described-herein shortcomings or technical problems by providing methods, systems, and apparatuses for modeling complex environments, for instance environments that include unknown devices or inherent uncertainties, so that autonomous machines can operate in these environments. Such environments may include brownfield devices, and thus models described herein account for brownfield devices. Brownfield devices refer to devices that may have been already installed in a particular environment, and thus an autonomous machine in the particular environment may encounter the brownfield devices. In some cases, the models that account for the brownfield devices might not have to access to a particular device's location, specifications, CAD information, kinematics, and/or operational behavior.

In various embodiments described herein, rather than programming autonomous devices with detailed instructions that may be specific to a particular environment having certainty, autonomous machines are programmed with product specific goals. By way of example, a product goal may be to assemble an electric cabinet based on available components and based on a digital twin of the cabinet. To do so, an autonomous machine might need to fasten components with rivets in available holes. Continuing with the example, the autonomous machine may automatically detect (e.g., with a camera) various details. Example details that may be detected include, without limitation, which components are available, from where the components need to be picked up, where the components need to be placed (e.g., so as to avoid collisions or damage to parts), where the rivets need to be placed, and which tools are optimal for the current task.

There are various technical problems or subproblems that may be encountered when addressing issues associated with implementing autonomous machines in various environment. An example subproblem is collision avoidance. To design an autonomous machine or agent that avoids unwanted collisions in a given environment, in some cases, a real-time map of the environment is built, and the autonomous machine is localized in the map. By way of example, an algorithm, such as the simultaneous localization and mapping (SLAM) algorithm, can estimate or model positions of the autonomous machine. Further, SLAM can utilize various depth sensors, such as distance sensors, LiDARS, dual cameras, and/or 3D point cloud cameras, to collect sensor data. Further still, algorithms such as SLAM can construct a map of collision surfaces based on the positions of the autonomous machine that are estimated/modeled, and also based on the sensor data that is collected from the depth sensors. The map of collision surfaces, or the collision map, can enable a system, in particular an autonomous machine, to perform various operations without collisions, such as navigating complex hallways or variable obstacle locations (e.g., parked cars, pallets of goods). In some cases, a collision map can also enable a machine to avoid moving objects such as humans.

It is recognized herein, however, that such collision maps do not contain semantic details related to the environment. Example semantic details include, without limitation, which boundary is part of which machine, which types of machines are present in the environment, the functionality of the machines present in the environment, where a particular user interface is located on a device within the environment, how to operate user interfaces within the environment, kinematics related to how a robotic system can move, whether a door of a machine within the environment is currently open, how a door that is open within the environment can be closed, and the like. It is further recognized herein that such semantic details, among others, may be required for, or may enhance, operability of a given autonomous system within an environment. Further still, it is recognized herein that such details are generally not accessible by autonomous machines.

In another example approach to implementing autonomous machines in an industrial environment, a particular environmental model is engineered for a particular autonomous machine. By way of example, machine tending of a milling machine may require loading metal raw parts from a pallet into the milling machine, fastening the parts to the milling machine, activating a milling program to perform the milling operation, and unloading the milled part to another pallet. Continuing with the example, these tending operations can be performed by attaching a robotic arm to the milling machine in an exactly known position. A program that controls the robotic arm, or robot, can receive CAD information or models of the raw parts that are going to be milled. The program may then use a camera to detect the location of the parts. The robotic arm may grasp a given part at a taught point, which can be a prespecified location in the associated CAD model of the part. The robotic arm can then load the part at a defined location of the milling machine. Thereafter, the milling operation can be triggered, for instance manually by the robot interacting with a user interface or through execution of a software program that is triggered by the robot. After the milling operation is performed, the robot can grasp the part at a defined location and unload the part from the machine onto another pallet.

It is recognized herein that various knowledge used by the robot in the above example, such as knowledge concerning geometry of the parts, where the object needs to be grasped, where the object needs to be placed in the machine, and the like, is typically taught or hard coded. Further, in such an example, a relative position between the robot (e.g., robotic arm) and the milling machine, in particular an interface of the robot and milling machine, is fixed. Thus, operating the machine by pressing buttons using the robotic arm can be performed without additional information because the exact locations can be defined in a model of the machine, and relative positions between the machine and the robotic arm can be fixed. It is recognized herein, however, that the design for such an application is generally device-specific, and lacks flexibility to address variation in a given environment. For example, in the above example, if a new machine is added to the environment, generating a new model that includes the new machine can be time-intensive, such that the benefits of automating the tasks can be diminished or outweighed by the costs. Further, such an implementation lacks autonomy, as variation in the environment is not captured in the model. For example, if the robot in the above example is not fixed to the milling machine, but instead is part of a mobile platform, then there is uncertainty in the position of the robot with respect to the milling machine, and a hard-coded approach to automating the task may fail.

In some cases, models can be automatically generated using deep learning-based object recognition algorithms. For example, a system can have several machines in a database that can be recognized by type, location, and orientation in a workspace (e.g., using a neural network such as the PointNet neural network). Such a system can enable fast interaction with known parts. By combining this with real-time mapping algorithms, an autonomous system can avoid obstacles and collaborate with humans. It is recognized herein, however, that these types of system designs might not account for brownfield devices or other devices with no CAD or kinematic information that is readily accessible for building an operational model. Further, such systems often cannot interact with objects that are not in the database. For example, it might not be possible for the system to place screws in available threads of an unknown workpiece, as the salient locations and collision bodies of the workpiece are not in the database, and thus are not modeled in the environment.

In view of above-described limitations, among others, of current approaches to autonomous designs, embodiments described herein build on sensory input to automatically add objects, machines, tools, workpieces, and the like into a world model. A world model refers to a virtual representation of a given environment (or world), in which an autonomous machine may operate. The world model can include various information, such as, for example and without limitation, information related to physical parts such as collision bodies, kinematic information related to how to operate various equipment (e.g., doors), markers on areas of interest to operate, etc. In some cases, a world model can be animated and simulated by a simulator, for instance a physics simulator. Thus, world model and simulation environment can be used interchangeably herein without limitation, unless otherwise specified. A simulation can represent the believed behavior of objects or situations in the environment of the autonomous machine. For example, if a part moves on a conveyer belt at a defined speed and the autonomous machine is moving its sensors away from observing the object, a physics simulator may continue to move the object in a simulation so as to represent a believed position of the object, even though the actual position of the object is not being observed because the sensors moved away from the object. World models, in particular simulations, can be used by an autonomous machine to plan future behaviors. In particular, for example, autonomous machines can behave or operate based on currently measured observations and simulated believed states or behaviors of the environment.

A given world model can be used to plan autonomous actions and can also validate policies through simulations. For example, the world model can utilize cameras, lidars, force, vibration, and other sensors to observe a scene or environment. Thus, in accordance with various embodiments, unknown objects can be automatically added to a simulated environment that can be used for real-time task planning. Additionally, in some embodiments, to represent the physical dimensions of various objects, semantic information can be extracted and input into a world model, which can enable machines to interact with previously unknown machines, tools, workpieces, or the like.

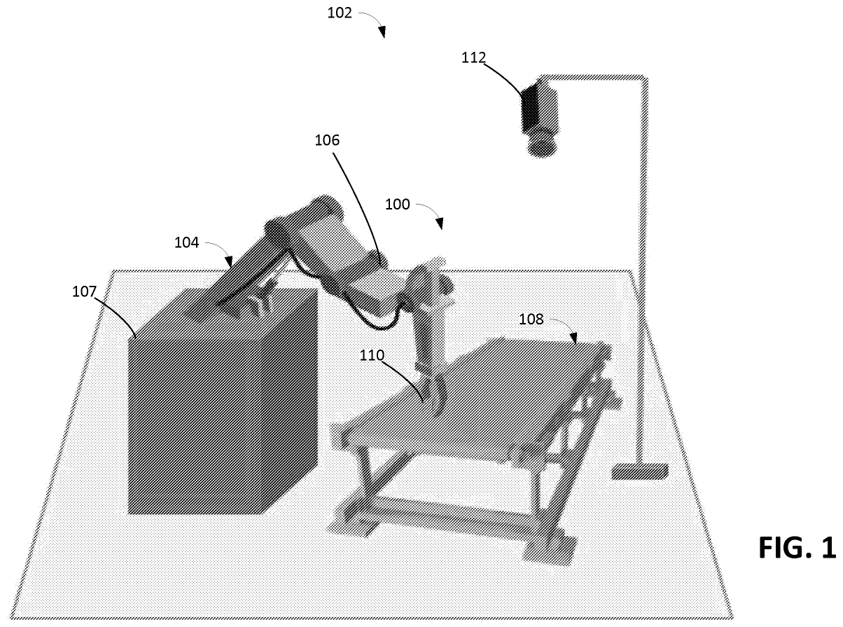

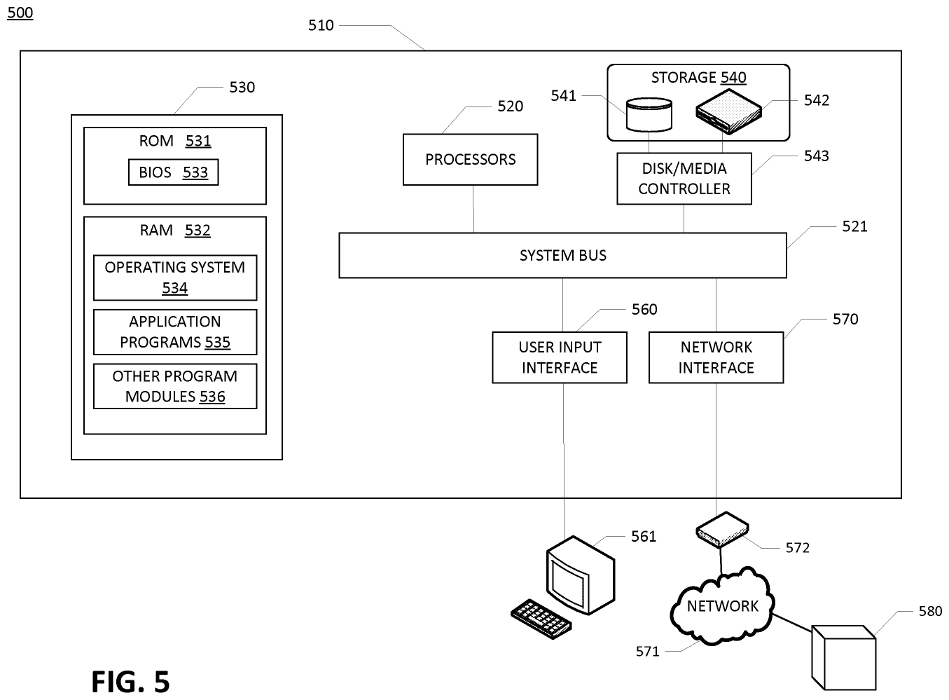

Referring now to FIG. 1, an example industrial or physical environment or scene 100 is shown. As used herein, the industrial environment 100 can refer to a physical environment, and a simulated or simulation environment (or world model) can define a virtual representation of the physical environment. The example industrial environment 100 includes an autonomous system 102 that includes a robot device or autonomous machine 104 and a conveyor 108 configured to interact with each other to perform one or more industrial tasks. The system 102 can include one or more computing processors configured to process information and control operations of the system 102, in particular the robot device 104. In an example, the robot device 104 includes one or more processor, for instance a processor 520 (see FIG. 5). An autonomous system for operating an autonomous machine within a physical environment can further include a memory for storing modules. The processors can further be configured to execute the modules so as to process information and generate simulation environments. It will be understood that the illustrated environment 100 and system 102 are simplified for purposes of example. The environment 100 and the system 102 may vary as desired, and all such systems and environments are contemplated as being within the scope of this disclosure.

The autonomous machine 104 further includes a robotic arm or manipulator 106 and a base 107 configured to support the robotic arm 106. The base 107 can include wheels or can otherwise be configured to move within the environment 100. The autonomous machine 104 can further include an end effector 110 attached to the robotic arm 106. The end effector 110 can include a gripper or one more tools configured to grasp and/or move objects. The robotic arm 106 can be configured to move so as to change the position of the end effector 110, for example, so as to place or move objects on the conveyor 108. The system 102 can further include one or more cameras or sensors, for instance a three-dimensional (3D) point cloud camera 112, configured to detect and record objects in the environment 102. The camera 112 can be configured to generate a 3D point cloud of a given scene, for instance the environment 100. Alternatively, or additionally, the one or more cameras of the system 102 can include one or more standard two-dimensional (2D) cameras that can record images (e.g., RGB images or depth images) from different viewpoints. Those images can be used to construct 3D images. For example, a 2D camera can be mounted to the robotic arm 106 so as to capture images from perspectives along given trajectory defined by the arm 106. Thus, an autonomous system can include a sensor configured to detect an object within a given physical environment. Further, as described herein, the object can define a plurality of subcomponents.

In accordance with various embodiments, the industrial environment 100 is learned and/or simulated by the system 102 so as to generate a simulated environment or world model. The camera 112 can be configured to detect and recognize known objects in the environment 100, such as the robotic arm 106, the base 107, the conveyor 108, and the end effector 110. In particular, the camera 112 can detect the relative positions of the known objects with respect to each other. Based on the detection of the known objects, the system 102 can automatically place the detected objects in the simulated environment. The relative positions of the objects in the simulated environment, which are based on the detection by the camera 112, can be the same as the relative position of the objects in the physical environment 100. It is recognized herein that placing objects in the simulated environment based on detection rather than, for example, based on dragging and dropping objects from a library into the stimulated environment (e.g., hand-engineering), can improve accuracy of the simulated environment. For example, hand-engineering approaches might not account for uncertainties in the physical setup of the objects in the physical environment 100, which can be due to manufacturing tolerances or other imprecisions. By way of example, the robotic arm 106 may have been physically installed in the physical environment 100 with an offset, for instance a 1 cm offset, as compared to its intended location. If the simulated environment is generated using hand-engineering approaches, the position or orientation of the robotic arm in the simulated environment will be offset as compared to the position or orientation of the robotic arm 106 in the physical environment 106. This may result in issues, such as misaligned grasp coordinates, in the physical environment. In contrast, in accordance with various embodiments, the actual offset as compared to the intended or designed location can be detected by the camera 112, and thus the position or orientation of the robotic arm in the simulated environment may accurately reflect the position or orientation of the robotic arm 106 in the physical environment 106.

With continuing reference to FIG. 1, the camera 112 can be positioned over the system robot 104 and the conveyor 106, or can otherwise be disposed so as to continuously monitor any objects within the environment 100. For example, when a new object is disposed or moves within the environment 100, the camera 112 can detect the new object. In some cases, the camera 112 can scan the new object and a process of the system 102 can convert the scan into a mesh representation of the new object. The mesh representation can be added to the simulated environment such that the new object can be simulated. In particular, the new object can be simulated so as to interact with the robot device 104.

Thus, the camera 112 can continuously track or monitor the environment 100 and add collision bodies or objects to a simulated environment as the objects appear in the physical environment 100. For example, if an object, such as an automated guided vehicle (AGV), drives through space of the environment 100 that is monitored by the camera 112, the space that the AGV occupies can be blocked so as to avoid collisions by the robot device 104. In particular, for example, the spaced occupied by the AGV can be blocked within the simulated environment, such that the robotic arm 108 is controlled such that its path does not include the space occupied by the AGV. In some cases, the system 102 can send a request, for instance to a plant coordination system, for a communication address of the AGV. Alternatively, or additionally, the system 102 can request, from the plant coordination system, one or more planned operations of the AGV. After obtaining the address of the AGV and/or the planned operations of the AGV, the system 102, for instance the processor of the robot device 104, can send a request to the AGV so as to interact with the AGV. For example, the robot device 104 can request that the AGV moves, or the robot device can load the AGV and trigger the AGV to move after it is loaded.

By way of another example, with continuing reference to FIG. 1, the camera 112 can detect if objects, such as workpieces, are being transported on the conveyor 108. If a given object is detected that is known by the system 102, for instance information related to the object is stored in a database accessible to the system 102, the known object can be represented in its detected position and orientation in a simulation. If a given object is detected that is unknown to the system 102, for instance information related to the object is not stored in a database that is accessible to the system 102, the unknown object (e.g., a brownfield device) can be represented in the simulation by a collision boundary generated by the camera 112. In particular, the camera 112 can scan the unknown object to generate an image of the unknown object, and the image can be converted into a mesh representation of the unknown object. The mesh representation can be imported in the simulation environment. Based on the mesh representation in the simulation environment, the system 102, in particular the robot device 104, can interact with the unknown object. Such interactions may include various operations that are performed by the robot device 104. Operations include, without limitation, picking up the object, painting the object, inserting screws in available threads of the object, or the like. Such operations can be performed without specialized engineering that is specific to the object.

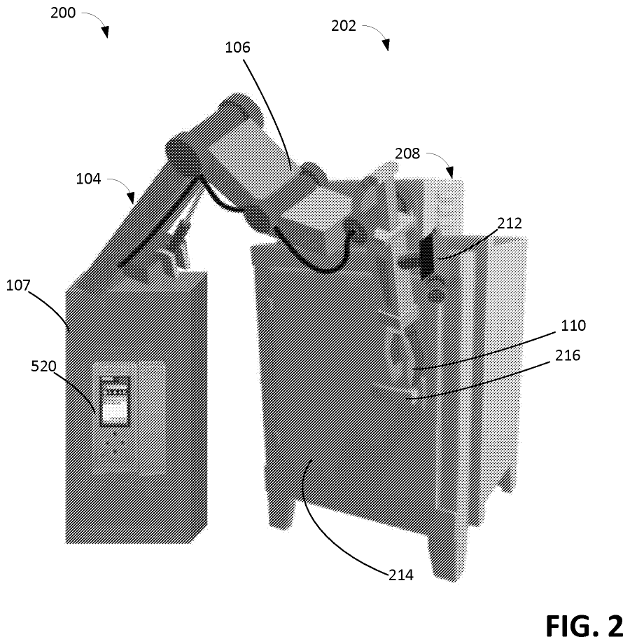

Referring also to FIG. 2, one or more sensors can also be used to detect subcomponents of various objects in various scenes, in accordance with various embodiments. Such subcomponents can be parameterized. FIG. 2 depicts another example industrial environment or scene 200 that includes another example autonomous system 202. The example system 202 includes an object or industrial machine 208 and the robot device 104 that can be configured to interact with the industrial machine 208. The industrial machine 208 includes a door 214 that defines a handle 216. It will be understood that the illustrated environment 200 and system 202, which includes the example industrial machine 208, are simplified for purposes of example. That is, the environment 200 and the system 202 may vary as desired, and all such systems and environments are contemplated as being within the scope of this disclosure.

The robot device 104 can further include one or more cameras, for instance an imaging sensor 212 mounted on the arm 106 of the robot device 104. The imaging sensor 212 can be configured to generate a 3D point cloud of a given scene. In some examples, the sensor 212 can be configured to capture images that define different views of one or more objects within the environment of the arm 106. Images that are captured can include 3D images (e.g., RGB-D images), or appropriately configured 2D images (e.g., RGB images or depth images).

In another aspect, one or cameras of the system, for instance the imaging sensor 212, can be used to detect one or more parameterized subcomponents of a scene, for instance the environment 200. It is recognized herein that it might not be feasible to store information for all brownfield devices in a library or database. Instead, in accordance with various embodiments, information related to common subcomponents can be learned, stored, and retrieved by the robot device 104. By way of example, subcomponents may refer to, without limitation, doors, touch panels, switches, other physical interfaces, threaded holes, or the like. Such subcomponents can differ, for example, depending on the machine of which they are a part. Subcomponents of the industrial machine 208 include the door 214 and the handle 216. Thus, the sensor 212 can be configured to detect an object (e.g., machine 108) within the environment 200, and the object can define a plurality of subcomponents (e.g., door 214, handle 216). The sensor 212 can be further configured to detect a subcomponent, for instance the handle 216, of the plurality of subcomponents so as to define a detected subcomponent.

The autonomous system 202 can also be configured to receive tasks, for instance a task that requires that the autonomous machine interacts with an object, such as the machine 208. Example tasks include, without limitation, picking up an object, painting an object, inserting screws in available threads of the object, or tending to a machine, which may include various tasks such as loading the machine, unloading the machine, or controlling the machine via a user display or interface. By way of further example, referring to FIG. 2, the system 202 may receive a task that requires the autonomous machine to load or unload the machine 20, which may require the autonomous machine to operate the handle 216 so as to open the door 214.

In an example, the robotic device 104 can classify (or determine a classification of) a detected subcomponent of a given machine, for instance the handle 216 or door 214 of the industrial machine 208, based on detecting the handle 216 or door 214, respectively, via the sensor 212. In particular, continuing with the example, the system 202 can include a neural network that can be trained with training data that includes images of various doors. After training, the sensor 212 can capture images of the door 214, and based on the one or more images of the door 214, the neural network, and thus the system 202, can identify that the detected object is a door. Thus, the robotic device 104 can be configured to recognize the door 214 even if the robotic device has not previously encountered the door 214. In some cases, the robotic device 104 can identify the door 214 as a door even if the physical operating principle (or principle of operation) of the door (e.g., sliding door) is different than doors that the robotic device 104 has previously encountered. Similarly, the robot device 104 can identify the handle 216 as a handle even if the physical principle of operation associated with the handle (e.g., pull up or push down or tum clockwise) is different than handles that the robot device 104 has previously encountered.

Based on the classification of the detected subcomponent, the autonomous system can determine a principle of operation associated with the detected subcomponent. For example, the door 214, and in particular the handle 216, can define features for interacting with the machine 208. The features can be detected by the system, and using those features, the subcomponent can be classified. Further, as described above, the robot device 104 can identify collision surfaces defined by the industrial machine 208. Thus, based on the detecting and identifying the collision surfaces and features (e.g., classification of subcomponents) for interacting with a given machine, the robot device 104 can interact with the machine without human intervention so as to operate in an automatic manner. For example, after determining the principle of operation of the detected subcomponent (e.g., handle 216), the autonomous machine 104 can perform the principle of operation associated with the detected subcomponent, so as to complete a given task (e.g., loading the machine) that requires that the autonomous machine interacts with the machine 208.

Further, information related to the machine 208, such as the identified collision surfaces or features for interaction (e.g., handle 216) can be added to a world model or simulation environment. For example, information related to the principle of operation associated with a subcomponent of an object can be stored and processed in a world model such that the information can be retrieved for future use. In some cases, the information related to the principle of operation associated with the subcomponent can be retrieved based on the classification of the subcomponent. Alternatively, or additionally, the information related to the principle of operation associated with the subcomponent can be retrieved for future use based on a future detection of the object or the subcomponent. Thus, in an example future operation, the robot device 104 can retrieve the information from the world model to open the door 214 of the machine 208, based on detecting a subcomponent that the system 202 classifies as a door or door handle, detecting the machine 208, or detecting the door 214 or handle 216.

Similarly, by way of another example, a touch panel can be identified by the robot device 104. After learning and identifying a given touch panel that may control a given machine, the robot device 104 can be configured to operate the machine via the touch panel in an automatic manner, for instance without human intervention. For example, the robot device can actuate an option, for instance a start button, on the touch panel to operate the machine. By way of another example, the robot device can actuate various options on a given machine to control a given machine such that the given machine performs specific tasks, such as tasks requested by an overlaying plant process controller. In some cases, the robot device 104 can learn and identify (classify) a given touch panel as a touch panel, even if the robot device 104, in particular a neural network of the robot device 104, was not trained on the given touch panel or has otherwise encountered the given touch panel. By way of example, a given touch panel may vary as compared to another touch panel, for instance the given touch panel may be a different size and/or color. Numbers and/or keys in the display of the given touch panel, however, may be similar to a touch panel that the robot device has previously encountered or to touch panels with which a neural network of the robot device 104 was trained. In such a case, the robot device 104 can recognize the numbers or keys of the touch panel, and can actuate the appropriate keys to interact with the touch panel, and thus the machine that is operated via the touch panel. Thus, the robot device 104 can be configured to interact with touch panels, and thus machines, which the robot device 104 has not previously encountered. By way of further example, the robot device 104 can identify an emergency stop button or door without previously encountering the emergency stop button or door. Thus, the robot device 104 can utilize deep learning, for instance one or more neural networks, to recognize and identify a class of an object (e.g., door, emergency button, user interface, handle, etc.). Further, based on the classification of the object, the robot device 104 can interact with the object even if the configuration of the object is not previously known to the robot device 104.

Referring in particular to FIG. 2, in another example aspect, autonomous machines can be configured to explore kinematics of objects so as to determine how to operate previously unknown mechanisms. In an example, the system 202 can determine that the robot device 104 has not previously interacted with the machine 208 within the environment 200. In some cases, the system 202 can detect a subcomponent of the plurality of subcomponents of the machine 208, in response to determining that the robot device 104 has not previously interacted with the machine 208. In particular, for example, the robot device 104 may receive a task that requires that the device 104 load the machine 208 with objects. If the robot device 104 determines that the device 104 has not previously encountered the machine 208, the device 104 may attempt to detect (locate) a door or other feature associated with loading.

After detecting the door or other features, by way of example, if the robot device 104 has not previously encountered the door 214 or the handle 216, the robot device 104 can explore the handle 216 so as to determine how to operate (e.g., open and close) the door 214. In particular, the sensor 212 in combination with a neural network (pattern or image recognition algorithm) implemented by the robot device 104 can detect and identify the handle 216 as a handle that operates the door 214. In some cases, although the robot device 104 can recognize the handle 216 as a handle, the robot device 104 might not have knowledge related to how the specific handle or how the specific door functions. That is, the robot device 104 might not know the principle of operation of a detected subcomponent. In particular, for example, the robot device 104 might not know whether the handle 216 operates by being pressed down, pressed up, rotated, or the like. Similarly, as another example, the robot device 104 might not know whether the door 214 operates by being slid sideways, being slid upward, being rotated about a hinge, or the like. In an example operation, the robot device 104 determines that the machine 208 is loaded by opening the door 214 that the robot device 104 detects, but the robot device 104 is unaware of the kinematics associated with the door 214. In an example, based on identifying and classifying the subcomponent as a door, the robot device 104 can retrieve policies associated with opening a door. The robot device 104 can implement the policies to explore different operations until the door opens, such that the robot device 104 can determine how to open the door 214.

Thus, as described above, the robot device 104 can implement policies to explore how objects operate in physical environments. For example, to determine a given principle of operation associated with a detected subcomponent, the system 202 can retrieve a policy, for instance from a world model, which can be associated with the classification of the detected subcomponent. The policy can indicate the principle of operation. In another example, the system 202 might recognize the detected subcomponent so as to determine an identity of the subcomponent. Based on the identity of the detected subcomponent, in some cases, the system can retrieve the principle of operation associated with the detected subcomponent. Recognizing the detected subcomponent, in some examples, can include determining that the autonomous machine 104 has previously interacted with the detected subcomponent.

As described herein, in various examples, the system 202 can retrieve one or more policies associated with the classification of the detected subcomponent. In some cases, the policies may be associated with the subcomponents of a machine or object, rather than the machine or object itself. For example, the robot device 104 may identify and retrieve a policy associated with the handle 216. In some cases, the robot device 104 can include a force sensor that is configured to measure and limit stress applied to a particular machine, so as to prevent damage when attempting various operations in accordance with a policy. In an example, a policy can indicate a plurality of potential principles of operation associated with a subcomponent, wherein the actual principle operation is one of the potential principles of operation. The plurality of potential principles of operation can be arranged in an order of likelihood of success, based on one or more features of the detected subcomponent. For example, the policy for a particular door handle may indicate that the robot device should try to rotate first, then push down, then pull up. The order of operations in a given policy may be based on the historical likelihood that an object having a particular shape has a particular principle operation. For example, based on the detected shape of the door handle 216, it may be likely that the door 214 opens when the handle 216 is pressed down. Thus, continuing with the example, the policy associated with the handle 216 may require that the robot device first tries to open the door 214 by pressing the handle 216 down. In some examples, the robot device 104 performs each of the potential principles of operation in the order that is indicated in the policy until the task is complete. Thereafter, the policy associated with the subcomponent and/or task can be updated to indicate the actual principle of operation. Without being bound by theory, it is recognized herein that exploring policies associated with subcomponents of a machine rather than policies associated with the machine itself, may scale better such that a given autonomous machine can better interact with unknown objects.

In some examples, the robot device 104 can deviate from known policies and can explore new policies (e.g., using another handle or traveling a different path) by using reinforcement learning, such as guided policy search. For example, referring to FIG. 2, a reward function can reward moving the door 214 out of its current position to enable an opening into the machine 208. The robot device 104 may then explore different options while staying within a constraint. An example constrain can be that the machine 208 is not damage. In accordance with various examples, after the correct kinematics are discovered or determined by the robot device 104, information associated with the correct kinematics can be stored, for instance in a world model, and retrieved during a future operation. The information associated with the correct kinematics can be stored such that the information is associated with the machine and/or appropriate subcomponents of the machine. For example, information associated with the correct kinematics for opening the door 214 can be stored such that the information is associated with the machine 208, the door 214, and the door handle 216. Thus, if an autonomous machine encounters the machine 208, the door 214, or the door handle 216, it can retrieve the kinematic information associated with opening the door 214 based on recognizing the door 214, the handle 216, or the machine 208.

In an alternative aspect, an autonomous machine can infer kinematics based on observation. For example, the robot device 104 can detect an object, for instance the door 214, that is does not understand. In particular, the arm 106 can orient itself such that the sensor 212 can view the door 214, in particular the handle 216 of the door 214. The robot device 212 can render a request, via a user interface or communications link for example, to a human operator or machine. The request can indicate a task that the robot device 104 wants demonstrated. For example, the request can indicate that the robot device 104 wants to see the door 214 opened. In response to the request, the human operator or machine can open the door 214 while the door 214, in particular the handle 216, is within a view of the sensor 212. Thus, the robot device 104 can observe another machine or a human complete a task, such as a task that includes a door opening. In particular, for example, the robot device 104 can observe that the handle 216 of door 214 is pressed down and that the door 214 hinges forward. Based on the observed behavior, the robot device 104 can imitate the observed behavior so as to execute a new task. One or more policies can also be updated based on the observed behavior.

In yet another example, an autonomous machine can infer kinematics based on textual understanding. For example, the robot device 104 can detect an object, for instance the door 214, that is does not understand. In particular, the arm 106 can orient itself such that the sensor 212 can view the door 214, in particular the handle 216 of the door 214. The robot device 212 can render a request, via a user interface or communications link for example, to a human operator or machine that can read text, for instance from a manual, associated with the principle of operation of the handle 216. The request can indicate a task for which the robot device 104 wants instructions. For example, the request can indicate that the robot device 104 wants instructions related to the door 214. In response to the request, the human operator or machine can read or otherwise input the text to the robot device 104. Thus, the robot device 104 can receive instructions from audile or written text. In particular, for example, the robot device 104 can receive instructions that stipulate that the handle 216 of the door 214 is pressed down and that the door 214 hinges forward. Based on instructions in the text, the robot device 104 can implement the instructions so as to execute a new task. One or more policies can also be updated based on manuals or other instructions.

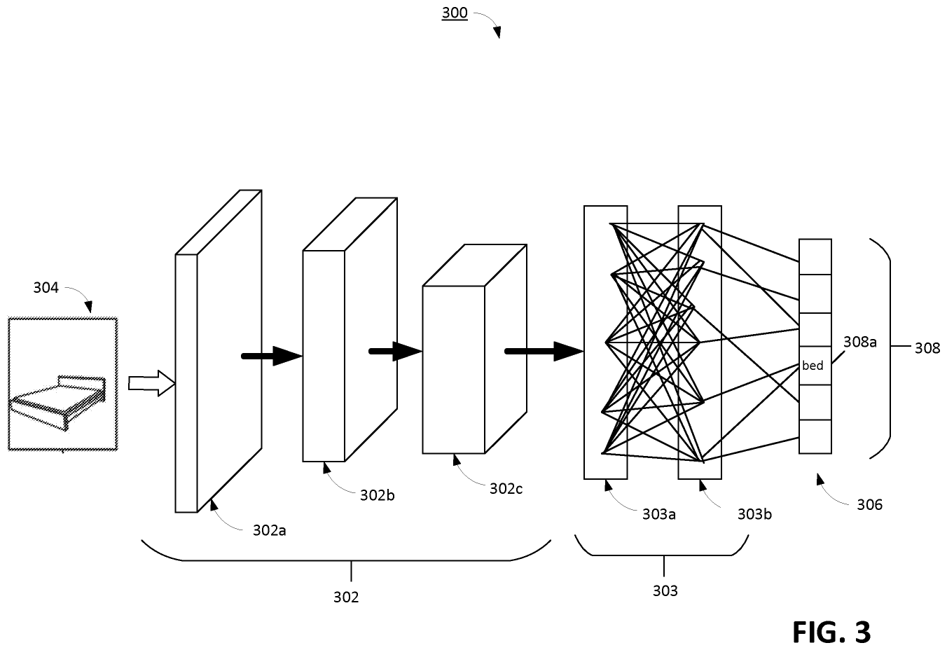

As described above, the robot device 104 and/or the systems 102 and 202 can include one or more neural networks configured to learn and identify various objects and subcomponents that can be found within various industrial environments. Referring now to FIG. 3, an example system or neural network model 300 can be configured to learn and classify objects and subcomponents, based on images for example, in accordance with various example embodiments. After the neural network 300 is trained, for example, images of detected subcomponents can be sent to the neural network 300 by the robot device 104 for classification. Based on classifications, policies can be retrieved and/or executed, and new principles of operation can be learned. Thus, in accordance with various examples, machine learning can be applied to learn objects, in particular subcomponents, and functionality of those objects or subcomponents.

The example neural network 300 includes a plurality of layers, for instance an input layer 302a configured to receive an image, an output layer 303b configured to generate class scores associated with the image, and a plurality of intermediate layers connected between the input layer 302a and the output layer 303b. In particular, the intermediate layers and the input layer 302a can define a plurality of convolutional layers 302. The intermediate layers can further include one or more fully connected layers 303. The convolution layers 302 can include the input layer 302a configured to receive training and test data, such as images. The convolutional layers 302 can further include a final convolutional or last feature layer 302c, and one or more intermediate or second convolutional layers 302b disposed between the input layer 302a and the final convolutional layer 302c. It will be understood that the illustrated model 300 is simplified for purposes of example. In particular, for example, models may include any number of layers as desired, in particular any number of intermediate layers, and all such models are contemplated as being within the scope of this disclosure.

The fully connected layers 303, which can include a first layer 303a and a second or output layer 303b, include connections between layers that are fully connected. For example, a neuron in the first layer 303a may communicate its output to every neuron in the second layer 303b, such that each neuron in the second layer 303b will receive input from every neuron in the first layer 303a. It will again be understood that the model is simplified for purposes of explanation, and that the model 300 is not limited to the number of illustrated fully connected layers 303. In contrast to the fully connected layers, the convolutional layers 302 may be locally connected, such that, for example, the neurons in the intermediate layer 302b might be connected to a limited number of neurons in the final convolutional layer 302c. The convolutional layers 302 can also be configured to share connections strengths associated with the strength of each neuron.

Still referring to FIG. 3, the input layer 302a can be configured to receive inputs 304, for instance an image 304, and the output layer 303b can be configured to return an output 306. The output 306 can include a classification associated with the input 304. For example, the output 306 can include an output vector that indicates a plurality of class scores 308 for various classes or categories. Thus, the output layer 303b can be configured to generate class scores 308 associated with the image 304. The class scores 308 can include a target class score 308a associated with a correct classification of the image 304. The class scores 108 can further include one or more confused or incorrect class scores. In the illustrated example, the target class score 108a corresponds to the “bed” classification, which is the correct label for the example image 104. As described herein, the output layer 303b can be configured to generate class scores 308 associated with various subcomponents of machines used in industrial settings, such as doors, handles, user interfaces, displays, workpieces, holes, plugs, or the like.

The input 304 is also referred to as the image 304 for purposes of example, but embodiments are not so limited. The input 304 can be an industrial image, for instance an image that includes a part that is classified so as to identify the part for an assembly. It will be understood that the model 300 can provide visual recognition and classification of various objects and/or images captured by various sensors or cameras, and all such objects and images are contemplated as being within the scope of this disclosure.

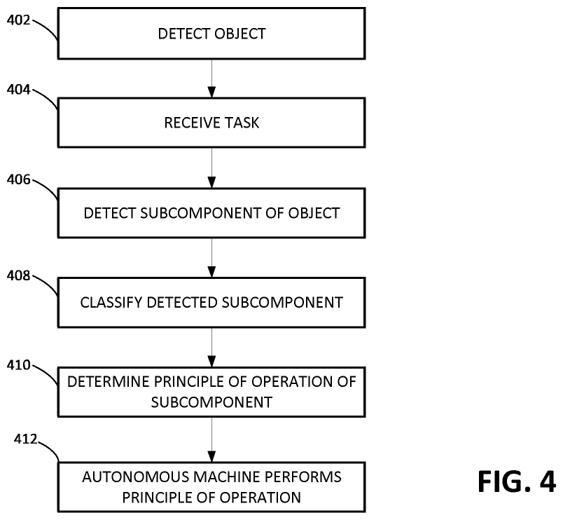

FIG. 4 shows a method for operating an autonomous machine, for instance the robot device 104, within a physical environment. In some cases, the method can be implemented by a processor that executes machine-readable instructions stored on a computer readable medium, for performing tasks and may comprise any one or combination of, hardware and firmware. The processor may also comprise memory storing machine-readable instructions executable for performing the tasks that can be performed by an autonomous system, for instance the system 102 or 202. Referring to FIG. 4, at 402, a system, for instance the system 102 or 202, detects an object within the physical environment. The object can define a plurality of subcomponents. At 404, the system receives a task that requires that the autonomous machine interacts with the object. At 406, a subcomponent of the plurality of subcomponents can be detected so as to define a detected subcomponent. Further, at 408, a classification of the detected subcomponent can be determined. Based on the classification of the detected subcomponent, a principle of operation associated with the detected subcomponent can be determined, at 410. Then, at 412, the autonomous machine can perform the principle of operation associated with detected subcomponent, so as to complete the task that requires that the autonomous machine interacts with the object. In some cases, the autonomous machine has not previously encountered the object.

FIG. 5 illustrates an example of a computing environment within which embodiments of the present disclosure may be implemented. A computing environment 500 includes a computer system 510 that may include a communication mechanism such as a system bus 521 or other communication mechanism for communicating information within the computer system 510. The computer system 510 further includes one or more processors 520 coupled with the system bus 521 for processing the information. The robot device 104 may include, or be coupled to, the one or more processors 520.

The processors 520 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 520 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 521 may include at least one of a system bus, a memory bus, an address bus, or a message bus, and may permit exchange of information (e.g., data (including computer-executable code), signaling, etc.) between various components of the computer system 510. The system bus 521 may include, without limitation, a memory bus or a memory controller, a peripheral bus, an accelerated graphics port, and so forth. The system bus 521 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 5, the computer system 510 may also include a system memory 530 coupled to the system bus 521 for storing information and instructions to be executed by processors 520. The system memory 530 may include computer readable storage media in the form of volatile and/or nonvolatile memory, such as read only memory (ROM) 531 and/or random access memory (RAM) 532. The RAM 532 may include other dynamic storage device(s) (e.g., dynamic RAM, static RAM, and synchronous DRAM). The ROM 531 may include other static storage device(s) (e.g., programmable ROM, erasable PROM, and electrically erasable PROM). In addition, the system memory 530 may be used for storing temporary variables or other intermediate information during the execution of instructions by the processors 520. A basic input/output system 533 (BIOS) containing the basic routines that help to transfer information between elements within computer system 510, such as during start-up, may be stored in the ROM 531. RAM 532 may contain data and/or program modules that are immediately accessible to and/or presently being operated on by the processors 520. System memory 530 may additionally include, for example, operating system 534, application programs 535, and other program modules 536. Application programs 535 may also include a user portal for development of the application program, allowing input parameters to be entered and modified as necessary.

The operating system 534 may be loaded into the memory 530 and may provide an interface between other application software executing on the computer system 510 and hardware resources of the computer system 510. More specifically, the operating system 534 may include a set of computer-executable instructions for managing hardware resources of the computer system 510 and for providing common services to other application programs (e.g., managing memory allocation among various application programs). In certain example embodiments, the operating system 534 may control execution of one or more of the program modules depicted as being stored in the data storage 540. The operating system 534 may include any operating system now known or which may be developed in the future including, but not limited to, any server operating system, any mainframe operating system, or any other proprietary or non-proprietary operating system.

The computer system 510 may also include a disk/media controller 543 coupled to the system bus 521 to control one or more storage devices for storing information and instructions, such as a magnetic hard disk 541 and/or a removable media drive 542 (e.g., floppy disk drive, compact disc drive, tape drive, flash drive, and/or solid state drive). Storage devices 540 may be added to the computer system 510 using an appropriate device interface (e.g., a small computer system interface (SCSI), integrated device electronics (IDE), Universal Serial Bus (USB), or FireWire). Storage devices 541, 542 may be external to the computer system 510.

The computer system 510 may also include a field device interface 565 coupled to the system bus 521 to control a field device 566, such as a device used in a production line. The computer system 510 may include a user input interface or GUI 561, which may comprise one or more input devices, such as a keyboard, touchscreen, tablet and/or a pointing device, for interacting with a computer user and providing information to the processors 520.

The computer system 510 may perform a portion or all of the processing steps of embodiments of the invention in response to the processors 520 executing one or more sequences of one or more instructions contained in a memory, such as the system memory 530. Such instructions may be read into the system memory 530 from another computer readable medium of storage 540, such as the magnetic hard disk 541 or the removable media drive 542. The magnetic hard disk 541 and/or removable media drive 542 may contain one or more data stores and data files used by embodiments of the present disclosure. The data store 540 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 520 may also be employed in a multi-processing arrangement to execute the one or more sequences of instructions contained in system memory 530. In alternative embodiments, hard-wired circuitry may be used in place of or in combination with software instructions. Thus, embodiments are not limited to any specific combination of hardware circuitry and software.

As stated above, the computer system 510 may include at least one computer readable medium or memory for holding instructions programmed according to embodiments of the invention and for containing data structures, tables, records, or other data described herein. The term “computer readable medium” as used herein refers to any medium that participates in providing instructions to the processors 520 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 541 or removable media drive 542. Non-limiting examples of volatile media include dynamic memory, such as system memory 530. Non-limiting examples of transmission media include coaxial cables, copper wire, and fiber optics, including the wires that make up the system bus 521. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 500 may further include the computer system 510 operating in a networked environment using logical connections to one or more remote computers, such as remote computing device 580. The network interface 570 may enable communication, for example, with other remote devices 580 or systems and/or the storage devices 541, 542 via the network 571. Remote computing device 580 may be a personal computer (laptop or desktop), a mobile device, a server, a router, a network PC, a peer device or other common network node, and typically includes many or all of the elements described above relative to computer system 510. When used in a networking environment, computer system 510 may include modem 672 for establishing communications over a network 571, such as the Internet. Modem 672 may be connected to system bus 521 via user network interface 570, or via another appropriate mechanism.

Network 571 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 510 and other computers (e.g., remote computing device 580). The network 571 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 571.

It should be appreciated that the program modules, applications, computer-executable instructions, code, or the like depicted in FIG. 5 as being stored in the system memory 530 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 510, the remote device 580, and/or hosted on other computing device(s) accessible via one or more of the network(s) 571, may be provided to support functionality provided by the program modules, applications, or computer-executable code depicted in FIG. 5 and/or additional or alternate functionality. Further, functionality may be modularized differently such that processing described as being supported collectively by the collection of program modules depicted in FIG. 5 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 5 may be implemented, at least partially, in hardware and/or firmware across any number of devices.

It should further be appreciated that the computer system 510 may include alternate and/or additional hardware, software, or firmware components beyond those described or depicted without departing from the scope of the disclosure. More particularly, it should be appreciated that software, firmware, or hardware components depicted as forming part of the computer system 510 are merely illustrative and that some components may not be present or additional components may be provided in various embodiments. While various illustrative program modules have been depicted and described as software modules stored in system memory 530, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for operating an autonomous machine within a physical environment, the method comprising:
detecting an object within the physical environment, the object defining a plurality of subcomponents;
receiving a task, the task requiring that the autonomous machine interacts with the object;
detecting a subcomponent of the plurality of subcomponents so as to define a detected subcomponent;
determining a classification of the detected subcomponent;
based on the classification of the detected subcomponent, determining a principle of operation associated with the detected subcomponent; and
performing, by the autonomous machine, the principle of operation associated with detected subcomponent, so as to complete the task that requires that the autonomous machine interacts with the object.

2. The method as recited in claim 1, the method further comprising:
determining that the autonomous machine has not previously interacted with the object within the physical environment; and
in response to determining that the autonomous machine has not previously interacted with the object with the physical environment, detecting the subcomponent of the plurality of subcomponents.

3. The method as recited in claim 1, wherein determining the principle of operation further comprises:
retrieving a policy associated with the classification of the detected subcomponent, the policy indicating the principle of operation.

4. The method as recited in claim 1, the method further comprising:
recognizing the detected subcomponent so as to determine an identity of the subcomponent; and
based on the identity of the detected subcomponent, retrieving the principle of operation associated with the detected subcomponent.

5. The method as recited in claim 4, wherein recognizing the detected subcomponent further comprises determining that the autonomous machine has previously interacted with the detected subcomponent, the method further comprising:
determining that the autonomous machine has not previously interacted with the object within the physical environment; and
in response to determining that the autonomous machine has not previously interacted with the object with the physical environment, detecting the subcomponent of the plurality of subcomponents.

6. The method as recited in claim 1, wherein determining the principle of operation further comprises:
retrieving a policy associated with the classification of the detected subcomponent, the policy indicating a plurality of potential principles of operation, wherein the principle of operation is one of the potential principles of operation.

7. The method as recited in claim 6, wherein the plurality of potential principles of operation are arranged in an order in the policy of likelihood of success, based on one or more features of the detected subcomponent.

8. The method as recited in claim 6, the method further comprising:
performing, by the autonomous machine, each of the potential principles of operation in the order until the task is complete.

9. The method as recited in claim 1, wherein determining the classification of the detected subcomponent further comprises:
training a neural network using images of the plurality of subcomponents; and
sending an image of the detected subcomponent to the neural network.

10. The method as recited in claim 1, wherein determining the principle of operation further comprises:
observing, by one or more sensors of the autonomous machine, another machine or human complete the task.

11. The method as recited in claim 1, the method further comprising:
storing information related to the principle of operation such that the information can be retrieved for future use based on a future detection of the object or subcomponent.

12. The method as recited in claim 1, the method further comprising:
storing information related to the principle of operation such that the information can be retrieved for future use based on the classification.

13. A system for operating an autonomous machine within a physical environment, the system comprising:
a sensor configured to:
detect an object within the physical environment, the object defining a plurality of subcomponents; and
detect a subcomponent of the plurality of subcomponents so as to define a detected subcomponent;
a memory for storing modules;
a processor for executing the modules configured to:
receive a task, the task requiring that the autonomous machine interacts with the object;
determine a classification of the detected subcomponent; and
based on the classification of the detected subcomponent, determine a principle of operation associated with the detected subcomponent; and
the autonomous machine, the autonomous machine configured to perform the principle of operation associated with detected subcomponent, so as to complete the task that requires that the autonomous machine interacts with the object.

14. The system as recited in claim 13, the modules further configured to:
determine that the autonomous machine has not previously interacted with the object within the physical environment; and
in response to determining that the autonomous machine has not previously interacted with the object with the physical environment, detect the subcomponent of the plurality of subcomponents.

15. The system as recited in claim 13, the modules further configured to:
retrieve a policy associated with the classification of the detected subcomponent, the policy indicating the principle of operation.

16. The system as recited in claim 13, the modules further configured to:
recognize the detected subcomponent so as to determine an identity of the subcomponent; and
based on the identity of the detected subcomponent, retrieve the principle of operation associated with the detected subcomponent.

17. The system as recited in claim 16, wherein recognizing the detected subcomponent further comprises determining that the autonomous machine has previously interacted with the detected component, the modules further configured to:
determine that the autonomous machine has not previously interacted with the object within the physical environment; and
in response to determining that the autonomous machine has not previously interacted with the object with the physical environment, detect the subcomponent of the plurality of subcomponents.

18. The system as recited in claim 13, the modules further configured to:
retrieve a policy associated with the classification of the detected subcomponent, the policy indicating a plurality of potential principles of operation, wherein the principle of operation is one of the potential principles of operation.

19. The system as recited in claim 18, wherein the plurality of potential principles of operation are arranged in an order in the policy of likelihood of success, based on one or more features of the detected subcomponent.

20. The system as recited in claim 18, the autonomous machine further configured to:
perform each of the potential principles of operation in the order until the task is complete.
